(19) United States
(12) Patent Application Publication
(10) Pub. No.: US 2021/0245477 A1
(43) Pub. Date: Aug. 12, 2021

(54) OPTICALLY CLEAR RESINS FOR THIN GLASS LAMINATES

(71) Applicant: CORNING INCORPORATED, CORNING, NY (US)

(72) Inventors: Jhee-mann Kim, Yongin-Si (KR); Joon-Soo Kim, Yongin-si (KR); Goo Soo Lee, Songpa-gu (KR)

(21) Appl. No.: 17/251,516

(22) PCT Filed: Jun. 18, 2019
(86) PCT No.: PCT/US2019/037681

§ 371 Date: Dec. 11, 2020

(30) Foreign Application Priority Data
Jun. 19, 2018 (KR) 10-2018-0070420
Aug. 2, 2018 (KR) 10-2018-0090408

(51) Int. Cl. B32B 17/10; B32B 15/092

(52) U.S. Cl. CPC B32B 17/10733; B32B 17/10743; B32B 2037/1253; B32B 2255/26; B32B 15/092

(57) ABSTRACT

A glass lamination article includes a resin layer in contact with a base substrate such that a first interface is formed therebetween, and a glass substrate layer in contact with the resin layer such that a second interface is formed therebetween, wherein the resin layer may be an ultraviolet (UV)-curable resin layer. The glass lamination article has excellent impact resistance and strength, as well as excellent waviness.

### CROSS-REFERENCE TO RELATED APPLICATION

This application claims the benefit of Korean Patent Application No. 10-2018-0070420, filed on Jun. 19, 2018, and Korean Patent Application No. 10-2018-0090408, filed Aug. 2, 2018, in the Korean Intellectual Property Office, the disclosure of which is incorporated herein in its entirety by reference.

### BACKGROUND

### 1. Field

One or more embodiments relate to a glass lamination article and a method of manufacturing the same, and more particularly, to a glass lamination article having excellent impact resistance and excellent strength, as well as excellent waviness, and a method of manufacturing the glass lamination article.

### 2. Description of the Related Art

An article obtained by laminating glass on a base substrate that is not glass by using an adhesive film has excellent chemical resistance and anti-scratch properties, as well as excellent flatness, when compared with a case in which a film formed of polyethylene terephthalate or polyvinyl chloride is adhered, and thus, an excellent appearance may be obtained.

However, since the strength or impact resistance of a glass substrate layer is insufficient, wide utilization of a glass lamination article in furniture, interior building materials, etc. is limited

### SUMMARY

One or more embodiments include a glass lamination article having excellent impact resistance and strength, as well as excellent waviness.

One or more embodiments include a method of manufacturing a glass lamination article having excellent impact resistance and strength, as well as excellent waviness.

Additional aspects will be set forth in part in the description which follows and, in part, will be apparent from the description, or may be learned by practice of the presented embodiments.

According to one or more embodiments, a glass lamination article includes a resin layer in contact with a base substrate such that a first interface is formed between the resin layer and the base substrate; and a glass substrate layer in contact with the resin layer such that a second interface is formed between the glass substrate layer and the resin layer, wherein the resin layer is an ultraviolet (UV)-curable resin layer.

The resin layer may include an acrylic resin or an epoxy-based resin. In some embodiments, the resin layer may include a homopolymer of any one repeating unit or a copolymer of any two or more repeating units selected from a group consisting of methyl (meth)acrylate, ethyl (meth)acrylate, butyl (meth)acrylate, dimethylaminoethyl (meth)acrylate, isobutyl (meth)acrylate, t-butyl(meth)acrylate, cyclohexyl (meth)acrylate, ethylhexyl (meth)acrylate, tetrahydroperfuryl (meth)acrylate, hydroxyethyl (meth)acrylate, 2-hydroxypropyl (meth)acrylate, 2-hydroxy-3-choloropropyl (meth)acrylate, 2-hydroxy-3-(meth)acryloyloxypropyl methacrylate, 4-hydroxybutyl (meth)acrylate, glycerol (meth)acrylate, methyl α-hydroxy methyl acrylate, ethyl α-hydroxymethyl acrylate, propyl α-hydroxymethyl acrylate, butyl α-hydroxymethylacrylate, 2-methoxyethyl (meth)acrylate, 3-methoxybutyl (meth)acrylate, ethoxydiethylene glycol (meth)acrylate, methoxytriethylene glycol (meth)acrylate, methoxytripropylene glycol (meth)acrylate, dipropylenegrycol di(meth)acrylate, tripropylenegrycol di(meth)acrylate, polypropylenegrycol di(meth)acrylate, polytetramethylenegrycol di (meth)acrylate, poly (ethyleneglycol) methyl ether (meth)acrylate, ethyleneglycol di(meth)acrylate, diethyleneglycol di(meth)acrylate, triethyleneglycol di(meth)acrylate, neopentylglycol di (meth)acrylate, propoxylated ethoxylated bisphenol A di (meth)acrylate, ethoxylated bisphenol A di (meth)acrylate, tetrafluoropropyl (meth)acrylate, tricyclodecanemethanol di (meth)acrylate, trimethylolpropane tri(meth)acrylate, ditrimethylolpropane tetra(meth)acrylate, 1,1,1,3,3,3-hexafluoroisopropyl (meth)acrylate, octafluoropenthyl (meth)acrylate, heptadecafluorodecyl (meth)acrylate, isobornyl (meth)acrylate, 1,10-decanediol di(meth)acrylate, 1,6-hexanediol di (meth)acrylate, 1,9-nonanediol di (meth)acrylate, dicyclopentanyl (meth)acrylate, dicyclopentenyl (meth)acrylate, dicyclopentanyl oxyethyl (meth)acrylate, and dicyclopentenyl oxyethyl (meth)acrylate, or a mixture of the homopolymer and/or the copolymer.

In some embodiments, the resin layer may include a homopolymer of any one repeating unit or a copolymer of any two or more repeating units selected from a group consisting of bisphenol A-type epoxy, bisphenol F-type epoxy, hydrogenated bisphenol A-type epoxy, hydrogenated bisphenol F-type epoxy, bisphenol S-type epoxy, brominated bisphenol A-type epoxy, biphenyl type epoxy, naphthalene type epoxy, fluorene type epoxy, spiro ring type epoxy, bisphenol alkanes epoxy, phenol novolac type epoxy, orthocresol novolac type epoxy, brominated cresol novolac type epoxy, tris(hydroxymethane) type epoxy, tetraphenylolethane type epoxy, alicyclic epoxy, and alcohol type epoxy or a mixture of the homopolymer and/or the copolymer.

In some embodiments, the resin layer may have a visible light transmittance of 90% or greater. In some embodiments, the glass substrate layer may have a thickness of about 100 μm to about 350 μm. In some embodiments, a flatness of the second interface may be greater than a flatness of the first interface. In some embodiments, a surface of the base substrate at a side of the first interface may have a waviness of about 3 μm or less. A surface of the glass substrate layer may have a Corning waviness index of 8 or greater. In some embodiments, the base substrate may include a high-pressure laminate (HPL), a paint-coated metal (PCM), or a vinyl-coated metal (VCM).

According to one or more embodiments, a method of manufacturing a glass lamination article includes: laminating a resin layer onto a base substrate; laminating a glass substrate layer onto the resin layer; and irradiating ultraviolet (UV) rays to the resin layer through the glass substrate layer to thereby cure the resin layer.

In some embodiments, the resin layer may include an acrylic resin or an epoxy-based resin. In some embodiments, the laminating of the UV rays may be performed for about 10 seconds to about 40 seconds. In some embodiments, the laminating of the glass substrate layer may be performed by a slot die coating method, a pattern dispensing method, or a roll coating method. In some embodiments, before the irradiating of the UV rays, the resin layer may have a viscosity of about 200 cps to about 7000 cps.

### BRIEF DESCRIPTION OF THE DRAWINGS

These and/or other aspects will become apparent and more readily appreciated from the following description of the embodiments, taken in conjunction with the accompanying drawings in which:

FIG. 1 is a cross-sectional view conceptually illustrating a glass lamination article according to an embodiment;

FIG. 2 is a cross-sectional view illustrating that a resin layer partially absorbs waviness of a side surface in a base substrate;

FIG. 3 shows images showing the Corning waviness index with respect to each index value;

FIG. 4 is a flowchart of a method of manufacturing a glass lamination article according to an embodiment;

FIGS. 5A to 5C are cross-sectional views sequentially illustrating the method of manufacturing the glass lamination article;

FIG. 6 shows images obtained by reflecting light from a tube-shape light source off each of glass lamination articles according to Experimental Examples 1-1 to 1-3;

FIG. 7 shows images obtained by reflecting light from a tube-shape light source off each of glass lamination articles according to Comparative Examples 1-1 to 1-3;

FIG. 8 shows images obtained by reflecting light from a tube-shape light source off each of glass lamination articles according to Experimental Examples 2-1 and 2-2;

FIG. 9 shows images obtained by reflecting light from a tubular light source off each of glass lamination articles according to Comparative Examples 2-1 and 2-2; and

FIG. 10 is a graph showing a variation in the percentage of samples destroyed according to a magnitude of a force applied downward in Experimental Examples 3-1 and 3-2 and Comparative Examples 3-1 and 3-2.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, one or more embodiments of the present disclosure will be described in detail with reference to accompanying drawings. Various modifications, additions and substitutions of the embodiment of the present disclosure are possible, and thus it will be appreciated that the present disclosure is not limited to the following embodiments. The embodiments of the present disclosure are provided so that this disclosure will be thorough and complete, and will fully convey the concept of the present disclosure to one of ordinary skill in the art. Like reference numerals may denote like elements throughout the specification. Moreover, various elements and regions in the drawings are schematically illustrated. Accordingly, the disclosure is not limited by relative sizes or intervals illustrated in the attached drawings.

It will be understood that although the terms “first,” “second,” etc. may be used herein to describe various components, these components should not be limited by these terms. Terms are only used to distinguish one element from other elements. For example, a first component may be referred to as a second component and vice versa, without departing from the scope of the present disclosure.

The terms used in the present specification are merely used to describe particular embodiments, and are not intended to limit the present disclosure. An expression used in the singular encompasses the expression of the plural, unless it has a clearly different meaning in the context. In the present specification, it will be understood that the terms “comprises” or “comprising,” when used in this specification, specify the presence of stated features, number, steps, operations, elements, components, and groups thereof, but do not preclude the presence or addition of one or more other features, number, steps, operations, elements, components, or groups thereof.

Unless otherwise defined, all terms used herein and including technical and scientific terms have the same meaning as those generally understood by one of ordinary skill in the art. Also, terms defined in commonly used dictionaries should be interpreted as having the same meanings as those in the context of related technologies, and unless clearly defined, are not interpreted as ideally or excessively formal meanings.

When a certain embodiment may be implemented differently, a specific process order may be performed differently from the described order. For example, two consecutively described processes may be performed substantially at the same time or performed in an order opposite to the described order.

In the drawings, for example, according to the manufacturing technology and/or tolerance, variations from the illustrated shape may be expected. Thus, the embodiments of the present disclosure must not be interpreted to be limited by a particular shape that is illustrated in the drawings and must include a change in the shape occurring, for example, during manufacturing. As used herein, “and/or” includes each and at least one all combinations of the mentioned items. Also, the term “substrate” used herein may denote the substrate itself, or a stack structure including a substrate and a predetermined layer or film formed on the substrate. Also, “surface of a substrate” used herein may denote an exposed surface of the substrate itself, or an outer surface of a predetermined layer or film formed on the substrate.

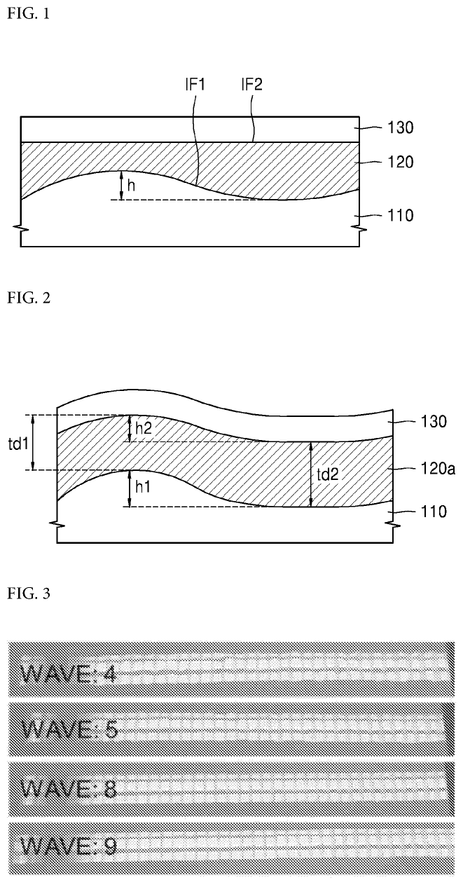

FIG. 1 is a cross-sectional view conceptually illustrating a glass lamination article 10 according to an embodiment.

Referring to FIG. 1, the glass lamination article 10 includes a base substrate 110, a resin layer 120 contacting the base substrate 110 while forming a first interface IF1, and a glass substrate layer 130 contacting the resin layer 120 while forming a second interface IF2.

The base substrate 110 may include a metal substrate, a wooden substrate, an inorganic substrate, an organic substrate, or a composite material thereof. The metal substrate may include steel, aluminum, copper, or other metal alloys, but is not limited thereto.

In some embodiments, the base substratematerial 110 may be obtained by coating the metal substrate, the wooden substrate, the inorganic substrate, the organic substrate, or a composite material thereof with an organic film. In some embodiments, the base substrate 110 may be obtained by coating the metal substrate, the wooden substrate, the inorganic substrate, the organic substrate, or a composite material thereof with a paint.

In some embodiments, the base substrate 110 may include a high-pressure laminate (HPL), a paint-coated metal (PCM), or a vinyl-coated metal (VCM). In some embodiments, the base substrate 110 may be used in wall panels, backsplash, exterior of a cabinet or furniture, exterior of home appliances, or other construction application articles.

A surface of the base substrate 110 may have a predetermined waviness, and FIG. 1 shows that the waviness is represented by a difference (h) between levels of a peak and a valley. The waviness may have a value of about 0.01 μm to about 3 μm. In some embodiments, the waviness may have a value of about 0.05 μm to about 2.5 μm, about 0.1 μm to about 2.2 μm, about 0.15 μm to about 2.0 μm, or about 0.2 μm to about 1.6 μm.

The resin layer 120 may include an adhesive resin material, and bonds the base substrate 110 to the glass substrate layer 130 that will be described later. In some embodiments, the resin layer 120 may be selected from photo-curing resins. In some embodiments, the resin layer 120 may include an ultraviolet (UV)-curable resin.

In some embodiments, the resin layer 120 may include, for example, an acrylic resin or an epoxy-based resin.

The acrylic resin may include a homopolymer of any one repeating unit or a copolymer of any two or more repeating units selected from a group consisting of monomoers of methyl (meth)acrylate, ethyl (meth)acrylate, butyl (meth)acrylate, dimethylaminoethyl (meth)acrylate, isobutyl (meth)acrylate, t-butyl(meth)acrylate, cyclohexyl (meth)acrylate, ethylhexyl (meth)acrylate, tetrahydroperfuryl (meth)acrylate, hydroxyethyl (meth)acrylate, 2-hydroxypropyl (meth)acrylate, 2-hydroxy-3-choloropropyl (meth)acrylate, 2-hydroxy-3-(meth)acryloyloxypropyl methacrylate, 4-hydroxybutyl (meth)acrylate, glycerol (meth)acrylate, methyl α-hydroxy methyl acrylate, ethyl α-hydroxymethyl acrylate, propyl α-hydroxymethyl acrylate, butyl α-hydroxymethylacrylate, 2-methoxyethyl (meth)acrylate, 3-methoxybutyl (meth)acrylate, ethoxydiethylene glycol (meth)acrylate, methoxytriethylene glycol (meth)acrylate, methoxytripropylene glycol (meth)acrylate, dipropylenegrycol di(meth)acrylate, tripropylenegrycol di(meth)acrylate, polypropylenegrycol di(meth)acrylate, polytetra methylene glycol di (meth)acrylate, poly (ethylene glycol) methyl ether (meth)acrylate, ethylene glycol di(meth)acrylate, diethylene glycol di(meth)acrylate, triethylene glycol di(meth)acrylate, neopentyl glycol di (meth)acrylate, propoxylated ethoxylated bisphenol A di (meth)acrylate, ethoxylated bisphenol A di (meth)acrylate, tetrafluoropropyl (meth)acrylate, tricyclodecane methanol di (meth)acrylate, trimethylolpropane tri(meth)acrylate, ditrimethylolpropane tetra(meth)acrylate, 1,1,1,3,3,3-hexafluoroisopropyl (meth)acrylate, octafluoropenthyl (meth)acrylate, heptadecafluorodecyl (meth)acrylate, isobornyl (meth)acrylate, 1,10-decanediol di(meth)acrylate, 1,6-hexanediol di (meth)acrylate, 1,9-nonanediol di (meth)acrylate, dicyclopentanyl (meth)acrylate, dicyclopentenyl (meth)acrylate, dicyclopentanyl oxyethyl (meth)acrylate, and dicyclopentenyl oxyethyl (meth)acrylate, or a mixture of the homopolymer and/or the copolymer.

The epoxy-based resin may include a homopolymer of any one repeating unit or a copolymer of any two or more repeating units selected from a group consisting of monomers of bisphenol A-type epoxy, bisphenol F-type epoxy, hydrogenated bisphenol A-type epoxy, hydrogenated bisphenol F-type epoxy, bisphenol S-type epoxy, brominated bisphenol A-type epoxy, biphenyl type epoxy, naphthalene type epoxy, fluorene type epoxy, spiro ring type epoxy, bisphenol alkanes epoxy, phenol novolac type epoxy, orthocresol novolac type epoxy, brominated cresol novolac type epoxy, tris(hydroxymethane) type epoxy, tetraphenylolethane type epoxy, alicyclic epoxy, and alcohol type epoxy, or a mixture of the homopolymer and/or the copolymer.

Among commercially available products, products that may be used as the resin layer 120 may include, for example, Henkel's 3193HS, 3381, 3311, and 3103 (acrylic resins), and 3335 (epoxy resin), but is not limited thereto.

The resin layer 120 may have a thickness of about 10 μm to about 200 μm. In some embodiments, the resin layer 120 may have a thickness of about 15 μm to about 150 μm, about 20 μm to about 100 μm, about 25 μm to about 70 μm, or about 30 μm to about 50 μm.

The glass substrate layer 130 may include a glass material containing about 30 mol % to about 85 mol % SiO₂, about 1 mol % to about 25 mol % Al₂O₃, about 0.1 mol % to about 15 mol % B₂O₃, about 0.1 mol % to about 10 mol % MgO, and about 0.1 mol % to about 10 mol % CaO. In some embodiments, the glass substrate layer 130 may further include, but is not limited to, Li₂O, K₂O, ZnO, SrO, BaO, SnO₂, TiO₂, V₂₀₃, Nb₂O₅, MnO, ZrO₂, As₂O₃, MoO₃, Sb₂O₃, and/or CeO.

The glass substrate layer 130 may have a thickness of about 50 μm to about 500 μm. In some embodiments, the glass substrate layer 130 may have a thickness of about 80 μm to about 400 μm, about 100 μm to about 350 μm, about 120 μm to about 300 μm, or about 150 μm to about 250 μm.

The glass substrate layer 130 may have a transmittance of about 90% or greater with respect to visible light. In some embodiment, the glass substrate layer 130 may have a transmittance of about 93% or greater, about 95% or greater, about 96% or greater, about 97% or greater, about 98% or greater, and about 99% or greater with respect to the visible light.

In some embodiments, the waviness of the first interface IF1 may be greater than the waviness of the second interface IF2. In other words, the second interface IF2 may have the flatness that is greater than that of the first interface IF1. To do this, the resin layer 120 may at least partially absorb the waviness of one side surface of the base substrate 110.

FIG. 2 is a cross-sectional view for illustrating that a resin layer 120a partially absorbs the waviness of one side surface of the base substrate 110.

Referring to FIG. 2, the base substrate 110 and the resin layer 120a are in contact with each other as the first interface IF1 interposed therebetween, and the resin layer 120a and the glass substrate layer 130 may be in contact with each other as the second interface IF2 is interposed therebetween.

As shown in FIG. 2, a representative value h1 of the waviness that the surface of the base substrate 110 has at the first interface IF1 may be greater than a representative value h2 of the waviness that a surface of the resin layer 120a has at the second interface IF2. In other words, the resin layer 120a may have a thickness td1 at a peak and a thickness td2 that is greater than the thickness td1 at a valley. That is, as shown in Equation (1) below, the representative value of the waviness is changed as much as a difference between the thicknesses of the resin layer 120a at the peak and the valley, and the waviness that one surface of the base substrate 110 has may be absorbed by the resin layer 120a.

(td2)−(td1)=(h1)−(h2) (1)

Since the resin layer 120 or 120a is in a liquid phase having a predetermined viscosity before being cured, the valley and the peak may have different thickness from each other. Thus, it is estimated that the waviness of the base substrate 110 is somewhat reduced on an upper surface of the resin layer 120 or 120a.

Since the glass substrate layer 130 has a substantially constant thickness, the waviness of the resin layer 120 or 120a may be substantially equal to the waviness of the glass substrate layer 130. The waviness on a surface of the glass substrate layer 130 may have a value of 8 or greater based on Corning waviness index defined by Corning, Inc.

FIG. 3 shows images showing a Corning waviness index with respect to each index value.

Referring to FIG. 3, when a tube-shape light source is used to illuminate the surface of the glass substrate layer, a degree of apparent straightness of a reflected image of the tube of the light source is scored to provide a criterion for evaluating waviness, and is used as one of criteria for evaluating the waviness of a certain surface. That is, the straightness of the image of light from the tube-shape light source reflected from a given surface is compared with criteria illustrated in FIG. 3 and then evaluated as a closest value among the criteria.

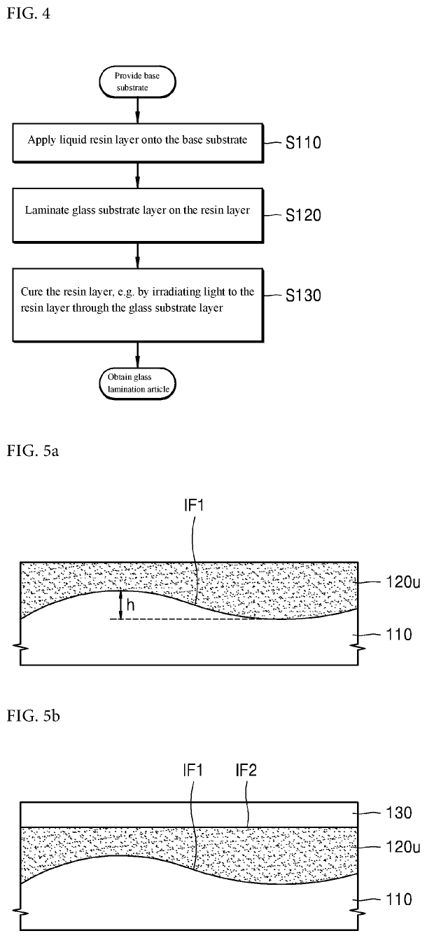

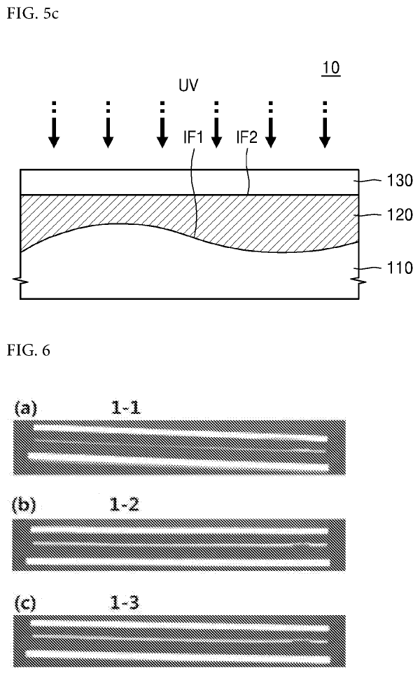

FIG. 4 is a flowchart of a method of manufacturing the glass lamination article 10 in a process order according to an embodiment. FIGS. 5A to 5C are cross-sectional views sequentially illustrating the method of manufacturing the glass lamination article 10.

Referring to FIGS. 4 and 5A, a resin layer 120u of a liquid phase is applied onto the base substrate 110 (S110). Since materials included in the resin layer 120u are described above with reference to FIG. 1, detailed descriptions thereof are omitted.

The resin layer 120u may have a viscosity of about 200 cps to about 7000 cps. In some embodiments, the resin layer 120u may have a viscosity of about 300 cps to about 5500 cps, about 400 cps to about 4500 cps, or about 500 cps to about 4000 cps.

When the viscosity of the resin layer 120u is too low, it is difficult to control a thickness of the resin layer and there may be a problem in levelling. On the contrary, when the viscosity of the resin layer 120u is too high, an effect of absorbing flatness of the first interface IF1 may be insufficient.

The resin layer 120u may be formed by using a slot die coating, a roll coating, a pattern dispensing, etc. In one embodiment, the resin layer 120u may be formed by the slot die coating method.

Referring to FIGS. 4 and 5B, the glass substrate layer 130 is laminated on the resin layer 120u (S120). Materials and dimensions of the glass substrate layer 130 are described above with reference to FIG. 1, and detailed descriptions thereof are omitted.

The glass substrate layer 130 may be laminated by using an arbitrary method capable of sufficiently attaching the glass substrate layer 130 to the resin layer 120u. When the glass substrate layer 130 is large in thickness, a nip roller may be used to laminate the glass substrate layer 130. However, when the nip roller is used in a case where the glass substrate layer 130 is small in thickness, the waviness of the base substrate 110 may be transferred to an upper surface of the glass substrate layer 130. Therefore, in a case where the glass substrate layer 130 is small in thickness, a method not applying a large amount of pressure to the glass substrate layer 130 may be used.

Referring to FIGS. 4 and 5C, light may be irradiated to the resin layer 120u through the glass substrate layer 130 to cure the resin layer 120u (S130). As described above, since the resin layer 120u includes the light-curing resin, the resin layer 120u may be cured by the irradiated light to form the cured resin layer 120.

In some embodiments, the resin layer 120u may include a UV-curable resin that may be cured by a UV ray, and in this case, the above light may be the UV ray.

The light may be irradiated to the resin layer 120u for about 10 sec. to about 40 sec. In some embodiments, the light may be irradiated to the resin layer 120u for about 15 sec. to about 38 sec., about 18 sec. to about 35 sec., or about 20 sec. to about 30 sec.

By curing the resin layer 120u, the glass lamination article 10 as shown in FIG. 1 may be obtained.

Hereinafter, structures and effects of the present disclosure will be described in detail with reference to experimental examples and comparative examples, but the experimental examples are only intended to clearly understand the present disclosure and are not to limit the scope of the present disclosure.

### Experimental Example 1-1

An HPL base substrate of a rough grade, that is, a surface thereof having a waviness of 2.15 μm, was provided, and the surface of the HPL base substrate was coated with a commercially available acrylic resin (Henkel 3193HS). Next, a glass substrate layer (Corning, Willow®) was laminated on the acrylic resin, and a UV ray was irradiated for 20 sec. to cure a resin layer.

### Experimental Example 1-2

A glass lamination article was manufactured in the same way as that of the experimental example 1-1, except that the HPL base substrate having a normal grade, that is, a surface thereof having a waviness of 1.38 μm, was used.

### Experimental Example 1-3

A glass lamination article was manufactured in the same way as that of the experimental example 1-1, except that the HPL base substrate having a smooth grade, that is, a surface thereof having a waviness of 0.86 μm, was used.

### Comparative Example 1-1

A glass lamination article was manufactured in the same way as that of the experimental example 1-1, except that an acrylic film was used instead of using the acrylic resin.

### Comparative Example 1-2

A glass lamination article was manufactured in the same way as that of the experimental example 1-2, except that an acrylic film was used instead of using the acrylic resin.

### Comparative Example 1-3

A glass lamination article was manufactured in the same way as that of the experimental example 1-3, except that an acrylic film was used instead of using the acrylic resin.

FIG. 6 shows images obtained by reflecting light from a tube-shape light source off each of glass lamination articles according to Experimental Examples 1-1 to 1-3.

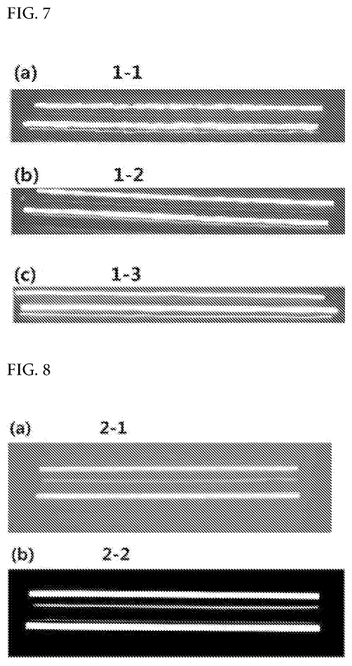

FIG. 7 shows images obtained by reflecting light from a tube-shape light source off each of glass lamination articles according to Comparative Examples 1-1 to 1-3.

Referring to FIGS. 6 and 7, surfaces of the glass lamination articles of Experimental Examples 1-1 to 1-3 have a Corning waviness index of 8 or greater and exhibit much greater flatness as compared to surfaces of the glass lamination articles of Comparative Examples 1-1 to 1-3. In other words, an excellent flatness was obtained by using the acrylic resin, rather than the acrylic film like in the prior art, in order to bond the base substrate to the glass substrate layer.

### Experimental Example 2-1

A deco steel base substrate of a normal grade, that is, a surface thereof having a waviness of 1.14 μm, was provided, and the surface of the deco steel base substrate was coated with a commercially available acrylic resin (Henkel 3193HS). Next, a glass substrate layer (Corning, Willow® ™??) was laminated on the acrylic resin, and a UV ray was irradiated for 20 sec. to cure a resin layer.

### Experimental Example 2-2

A glass lamination article was manufactured in the same way as that of Experimental Example 1-1, except that the deco steel base substrate having a smooth grade, that is, a surface thereof having a waviness of 0.52 μm, was used.

### Comparative Example 2-1

A glass lamination article was manufactured in the same way as that of Experimental Example 2-1, except that an acrylic film was used instead of using the acrylic resin.

### Comparative Example 2-2

A glass lamination article was manufactured in the same way as that of Experimental Example 2-2, except that an acrylic film was used instead of using the acrylic resin.

FIG. 8 shows images obtained by reflecting light from a tube-shape light source off each of glass lamination articles according to Experimental Examples 2-1 and 2-2.

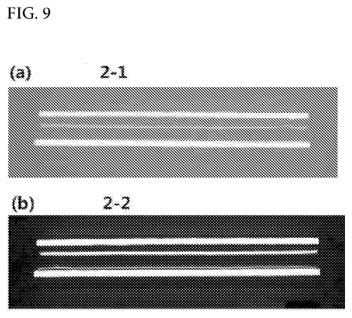

FIG. 9 shows images obtained by reflecting light from a tube-shape light source off each of glass lamination articles according to Comparative Examples 2-1 and 2-2.

Referring to FIGS. 8 and 9, surfaces of the glass lamination articles of Experimental Examples 2-1 and 2-2 have a Corning waviness index of 8 or greater and exhibit somewhat greater flatness as compared to surfaces of the glass lamination articles of Comparative Examples 2-1 and 2-2. In other words, excellent flatness was obtained by using the acrylic resin, rather than an acrylic film like in the prior art, in order to bond the base substrate to the glass substrate layer.

### Experimental Example 3-1

A puncture test was performed to identify the influence of the method of manufacturing the glass lamination article according to the embodiments on strength of the glass substrate layer.

With respect to an upper surface of the glass lamination article manufactured according to Experimental Example 1-1, that is, the glass substrate layer, whether the glass substrate layer would be destroyed was checked by applying forces of various magnitudes downward via a tip having a diameter of 0.2 mm. In addition, the number of destroyed samples with respect to each magnitude of the forces was counted to calculate percentages.

### Experimental Example 3-2

This experiment was performed in the same way as that of the Experimental Example 3-1 except that the diameter of the tip was changed from 0.2 mm to 2.0 mm.

### Comparative Example 3-1

This experiment was performed in the same way as that of the Experimental Example 3-1 except that the glass lamination article manufactured according to Comparative Example 1-1, not Experimental Example 1-1, was used.

### Comparative Example 3-2

This experiment was performed in the same way as that of Experimental Example 3-2 except that the glass lamination article manufactured according to Comparative Example 1-1, not Experimental Example 1-1, was used.

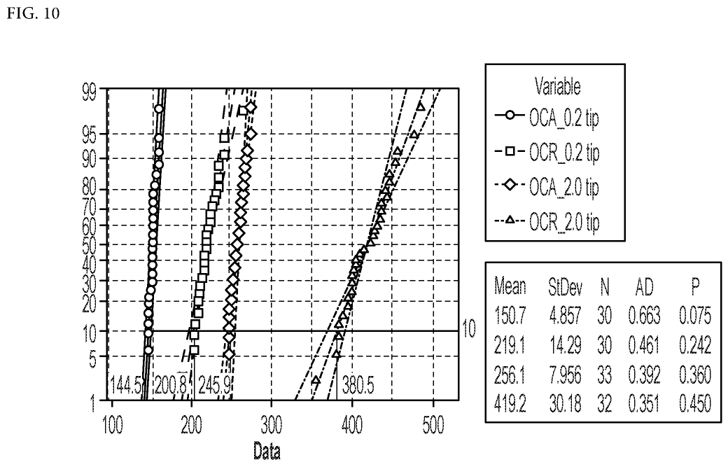

FIG. 10 is a graph showing a variation in the percentage of samples destroyed according to a magnitude of a force applied downward in Experimental Examples 3-1 and 3-2 and Comparative Examples 3-1 and 3-2.

Referring to FIG. 10, when the force is applied through the tip of the same diameter, the samples of Experimental Example 3-1 are more resistant to the downward force than the samples of Comparative Example 3-1. Moreover, the samples of Experimental Example 3-2 are more resistant to the downward force than the samples of Comparative Example 3-2.

In particular, when the force applied to the glass substrate layer was about 150 N, nearly 100% of the samples according to Comparative Example 3-1 were destroyed, but the samples according to Experimental Example 3-1 were rarely destroyed. In the cases of Experimental Example 3-2 and Comparative Example 3-2 in which the diameter of the tip was increased, the above trend was prominently exhibited and the difference also increased.

Table 1 below shows the magnitude of the force applied downward when the percentage of samples destroyed was 10% in Experimental Examples 3-1 and 3-2, and Comparative Examples 3-1 and 3-2. As shown in Table 1 below, it was identified that Experimental Example 3-1 was improved by about 39% as compared to Comparative Example 3-1, and Experimental Example 3-2 was improved by about 55% as compared to Comparative Example 3-2.

This may be interpreted that the strength of the glass lamination article manufactured according to the embodiments of the present disclosure is greatly improved as compared to a glass lamination article manufactured according to the prior art.

TABLE 1

| | Experimental | Comparative | |
|---|---|---|---|
| | Example | Example | |
| 3-1 | 144.5 N | 200.8 N | 39% |
| | | | improved |
| 3-2 | 245.9 N | 380.5 N | 55% |
| | | | improved |

### Experimental Example 4

A ball drop test was performed in order to identify the influence of the method of manufacturing the glass lamination article according to the embodiments on impact resistance of the glass substrate layer.

A steel ball having a mass of 110 g fell free from various initial heights onto the upper surface, that is, the glass substrate layer, of the glass lamination article manufactured according to Experimental Example 1-1 to observe whether the glass substrate layer was destroyed, and then, a minimum height at which the glass substrate layer was destroyed was obtained.

### Comparative Example 4

This experiment was performed in the same way as that of Experimental Example 4 except that the glass lamination article manufactured according to Comparative Example 1-1, not Experimental Example 1-1, was used.

TABLE 2

| | Comparative | Experimental |
|---|---|---|
| | Example 4 | Example 4 |
| Minimum destruction | 0.30 | 1.50 |
| height (m) | | |
| Minimum destruction | 0.32 | 1.62 |
| energy (J) | | |

As a result, as shown in Table 2 above, the glass substrate layer of Comparative Example 4 started to be destroyed at a height of 0.3 m, whereas the glass substrate layer of the experimental result 4 started to be destroyed at a height of 1.5 m, when the steel ball having the mass of 110 g did a free-fall. That is, the impact resistance of the glass substrate layer according to Experimental Example 4 was much more excellent than the impact resistance of the glass substrate layer according to Comparative Example 4.

Since the glass substrate layers in Experimental Example 4 and Comparative Example 4 are the same as each other, the impact resistance of the glass substrate layer may be appreciated as the impact resistance of the glass substrate layer in each of the manufactured glass lamination articles, rather than the impact resistance inherent in the glass substrate layer itself. That is, it is appreciated that the impact resistance of the glass substrate layer varies depending on whether there is a resin layer or a film layer between the glass substrate layer and the base substrate. In addition, it was observed that the impact resistance of the glass substrate layer in the glass lamination article manufactured according to the embodiments of the present disclosure was greatly improved as compared to the impact resistance of the glass substrate layer in the glass lamination article manufactured according to the prior art.

As described above, although the exemplary embodiments of the present disclosure have been disclosed, one of ordinary skill in the art will appreciate that various modifications are possible, without departing from the scope and spirit of the disclosure as disclosed in the accompanying claims. Therefore, all differences within the scope will be construed as being included in the present disclosure.

The glass lamination article according to the embodiments of the present disclosure has excellent impact resistance and strength, as well as excellent waviness.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the disclosure as defined by the following claims.

What is claimed is:

1. A glass lamination article comprising:
a resin layer in contact with a base substrate such that a first interface is formed between the resin layer and the base substrate; and
a glass substrate layer in contact with the resin layer such that a second interface is formed between the glass substrate layer and the resin layer, wherein the resin layer is an ultraviolet (UV)-curable resin layer.

2. The glass lamination article of claim 1, wherein the resin layer comprises an acrylic resin or an epoxy-based resin.

3. The glass lamination article of claim 2, wherein the resin layer comprises a homopolymer of any one repeating unit or a copolymer of any two or more repeating units selected from a group consisting of methyl (meth)acrylate, ethyl (meth)acrylate, butyl (meth)acrylate, dimethylaminoethyl (meth)acrylate, isobutyl (meth)acrylate, t-butyl(meth)acrylate, cyclohexyl (meth)acrylate, ethylhexyl (meth)acrylate, tetrahydroperfuryl (meth)acrylate, hydroxyethyl (meth)acrylate, 2-hydroxypropyl (meth)acrylate, 2-hydroxy-3-choloropropyl (meth)acrylate, 2-hydroxy-3-(meth)acryloyloxypropyl methacrylate, 4-hydroxybutyl (meth)acrylate, glycerol (meth)acrylate, methyl α-hydroxy methyl acrylate, ethyl α-hydroxymethyl acrylate, propyl α-hydroxymethyl acrylate, butyl α-hydroxymethylacrylate, 2-methoxyethyl (meth)acrylate, 3-methoxybutyl (meth)acrylate, ethoxydiethylene glycol (meth)acrylate, methoxytriethylene glycol (meth)acrylate, methoxytripropylene glycol (meth)acrylate, dipropylenegrycol di(meth)acrylate, tripropylenegrycol di(meth)acrylate, polypropylenegrycol di(meth)acrylate, polytetramethylenegrycol di (meth)acrylate, poly (ethyleneglycol) methyl ether (meth)acrylate, ethyleneglycol di(meth)acrylate, diethyleneglycol di(meth)acrylate, triethyleneglycol di(meth)acrylate, neopentylglycol di (meth)acrylate, propoxylated ethoxylated bisphenol A di (meth)acrylate, ethoxylated bisphenol A di (meth)acrylate, tetrafluoropropyl (meth)acrylate, tricyclodecanemethanol di (meth)acrylate, trimethylolpropane tri(meth)acrylate, ditrimethylolpropane tetra(meth)acrylate, 1,1,1,3,3,3-hexafluoroisopropyl (meth)acrylate, octafluoropenthyl (meth)acrylate, heptadecafluorodecyl (meth)acrylate, isobornyl (meth)acrylate, 1,10-decanediol di(meth)acrylate, 1,6-hexanediol di (meth)acrylate, 1,9-nonanediol di (meth)acrylate, dicyclopentanyl (meth)acrylate, dicyclopentenyl (meth)acrylate, dicyclopentanyl oxyethyl (meth)acrylate, and dicyclopentenyl oxyethyl (meth)acrylate, or a mixture of the homopolymer and/or the copolymer.

4. The glass lamination article of claim 2, wherein the resin layer comprises a homopolymer of any one repeating unit or a copolymer of any two or more repeating units selected from a group consisting of bisphenol A-type epoxy, bisphenol F-type epoxy, hydrogenated bisphenol A-type epoxy, hydrogenated bisphenol F-type epoxy, bisphenol S-type epoxy, brominated bisphenol A-type epoxy, biphenyl type epoxy, naphthalene type epoxy, fluorene type epoxy, spiro ring type epoxy, bisphenol alkanes epoxy, phenol novolac type epoxy, orthocresol novolac type epoxy, brominated cresol novolac type epoxy, tris(hydroxymethane) type epoxy, tetraphenylolethane type epoxy, alicyclic epoxy, and alcohol type epoxy or a mixture of the homopolymer and/or the copolymer.

5. The glass lamination article of claim 1, wherein the resin layer has a visible light transmittance of 90% or greater.

6. The glass lamination article of claim 1, wherein the glass substrate layer has a thickness of about 100 μm to about 350 μm.

7. The glass lamination article of claim 1, wherein a flatness of the second interface is greater than a flatness of the first interface.

8. The glass lamination article of claim 1, wherein a surface of the base substrate at a side of the first interface has a waviness of about 3 μm or less.

9. The glass lamination article of claim 8, wherein a surface of the glass substrate layer has a Corning waviness index of 8 or greater.

10. The glass lamination article of claim 1, wherein the base substrate comprises a high-pressure laminate (HPL), a paint-coated metal (PCM), or a vinyl-coated metal (VCM).

11. A method of manufacturing a glass lamination article, the method comprising:
applying a resin layer onto a base substrate;
laminating a glass substrate layer onto the resin layer; and
irradiating ultraviolet (UV) rays to the resin layer through the glass substrate layer to thereby cure the resin layer.

12. The method of claim 11, wherein the resin layer comprises an acrylic resin or an epoxy-based resin.

13. The method of claim 11, wherein the irradiating of the UV rays is performed for about 10 seconds to about 40 seconds.

14. The method of claim 11, wherein the laminating of the glass substrate layer is performed by a slot die coating method, a pattern dispensing method, or a roll coating method.

15. The method of claim 11, wherein, before the irradiating of the UV rays, the resin layer has a viscosity of about 200 cps to about 7000 cps.
